(19) United States
(12) Patent Application Publication
(10) Pub. No.: US 2014/0050583 A1
(43) Pub. Date: Feb. 20, 2014

(54) Vertical-shaft Wind Turbine Double-layer Reverse Rotation and Horizontal Active Wings

(71) Applicant: Zhaotai Wang, Laizhou (CN)

(72) Inventor: Zhaotai Wang, Laizhou (CN)

(21) Appl. No.: 13/586,868

(22) Filed: Aug. 16, 2012

(51) Int. Cl. F03D 3/00

(52) U.S. Cl. CPC F03D 3/00
USPC 416/98

(57) ABSTRACT

A vertical-shaft wind turbine double-layer reverse rotation and horizontal active wings consist of support devices and blades etc., characterized in that: further including a movable wing link gear, a positioning device, a stop device, an auxiliary start device, a speed adjusting device and blade shaft; wherein the movable wing link gear, the positioning device and the auxiliary start device are all mounted in the body of the wind turbine; the blades are associated with the blade shaft; the speed adjusting gear is between the blade shaft and the linkage gear of the movable wing link gear; the stop device is mounted on the side wall of the linkage gear case, the auxiliary limitation devices are mounted at the front ends of the top and lower blades and the tail of the top blade respectively.

### FIELD OF THE DISCLOSURE

The present invention relates to a wind power utilization device, in particular to a vertical-shaft wind turbine double-layer reverse rotation and horizontal active wings.

### BACKGROUND OF THE DISCLOSURE

The exploitation and utilization of wind have been increasingly developed. When it comes to the utilization rate of the wind energy, the vertical-shaft wind turbine is better than the horizontal shaft wind turbine. Therefore, people began to produce a vertical-shaft wind turbine as far back as the 1950s, and an American inventor has produced a large-scale vertical-shaft wind turbine that is 50 meters in the diameter. However, people did not bring about great advances, though have researched on the vertical-shaft wind turbine more than half a century. Considering data on various aspects, the existing vertical-shaft wind turbine has such disadvantages as follows:

1. Blades cannot move effectively as result of the gravity influence, and high-technology materials need to be used to reduce the weight of the blades, therefore increasing the costs. 2. Most of the movable joints are exposed, and in doing so, they are hard to be lubricated and easy to be corroded by snow, rain and dust; 3. Without speed-limiting device, it is hard to ensure the service life of the wind turbine.

The present invention applicant searched a patent application of a vertical-shaft wind turbine, which is named “vertical-shaft and vertical-wing wind turbine for vessels” and developed by a Japanese company; it has been put to use on a cruise ship and considered to be the most advanced. The applicant filed a Chinese patent application named “novel vertical-shaft and movable wing wind turbine” in 2004, before which the applicant has searched a good deal of patent technology in this field, based on which the applicant analyzed the operating principle of the patent of that Japanese company. We know that the vertical wing may be suspended form (blade shaft being on the top of the blades) or side shaft form, i.e. the blade shaft is on the opposite of the turbine shaft. If the wind turbine is suspended form, the blades must be made of special materials that can satisfy the rigidity requirements, meanwhile having lower density such as carbon fiber, which can ensure the backwind wing to flutter during operation. However, in doing so, the costs will greatly increase. If the wind turbine is side shaft form, it cannot renew to best ready mode after every machine halt, and cannot work effectively because the dirt is apt to accumulate below the wing shaft. In a word, said turbine still belongs to the traditional model of existing various vertical-shaft wind turbines.

### DISCLOSURE OF THE INVENTION

The author filed a utility model application in September 2004, and were granted certificate of the utility model on 3, May 2006, whose application number is ZL200420096160.2. Then I further improved the wind turbine based on above utility model, and filed an invention application, ZL2006101709097, named “Vertical shaft double-layer counter-rotation combined type horizontal active-wing wind turbine” on 23, Dec. 2006. It has already been in substantive examination. The single-layer wind turbine is improved to double-layer, counter-rotation and driving the same machine at the same time.

However, said invention has disadvantages yet; thus the author further improved the wind turbine based on said invention to file the present invention. Comparing to above invention, the present application has such two advantages:

One, linkage-gear position location devices are provided in present invention. When wind turbine works; the following-wind wings and the against-wind wings are open to their maximum angles, the position location device will lock them at those positions while the previous invention without such position location device. It is obvious via analysis that, when the following-wind wings are at an angle of 45° to the wind, the new following-wind wings almost blocks the wind force which should exert on the original against-wind wings, in doing so, the original against-wind wings keeping open at the angle entirely depends on the against-wind wings which are hard to keep absolute horizontality. Therefore, the wind turbine will renew to ready mode automatically, which will influence the efficiency of the wind turbine. According to present invention, the position location device is provided to lock its work position, which is when the following-wind wings are not in work, the following-wind wings and the against-wind wings are still kept in primary state. Thus, original following-wind wings can still utilize the wind force which has passed by the new following-wind; and the against-wind wings still kept horizontality and do not increase resistance. Therefore, the efficiency of the wind turbine is greatly increased.

Two, because the top layer wind turbine and the lower wind turbine are in relative motion state, the previous invention cannot provide an auxiliary start device. However, according to the present invention, an auxiliary start device is skillfully mounted on the lower wind turbine via a carrier gear; in doing so; the efficiency of the wind turbine is greatly increased.

The blades of the wind turbine is horizontal and the top blade and the lower blade form a group, which are at a same vertical line and connected by linkage gears. Meanwhile, two groups of the assembly wings which are connected by linkage gears also; therefore, the natural droop state of the two lower blades on left and right sides forces two top blades forming a V shape, in doing so, two blades on one side form “<” or “>” shape. However, this is a precarious balance, this transient state is immediately destroyed by external force, and wind wings quickly open more than 90°, while the against-wind wings are closed less than 90°. As a result, torsion difference is formed between the following-wind wings and the against-wind wings, and the wind turbine is started. Unique place in this wind turbine is the linkage gear and the blade shaft are slide cooperation, the spiral key slot on the blade shaft decide the open angle of the following-wind wings at different wind speeds, which is the key of mechanical speed governors, that is, when the wind turbine is over the rated speed, the blade shaft naturally slide outside, due to the spiral key slot, the open angle of the following-wind wings gradually decreases from nearly 180°, so that the speed of the wind turbine reduced certainly, and the service life of the wind turbine is ensured.

Comparing to the known wind turbines, the wind turbine according to the present invention has such advantages as follows:

(1) this wind turbine utilizes the unstable equilibrium principle, by which the strength is ensured and the weight of the blade needs not to be considered, which reduces production costs and increase the cost performance of the wind turbine;
(2) the wind turbine will automatically revert to the best standby after each shutdown and improve the efficiency;
(3) the most simple but most effective mechanical speed regulator is utilized, which can be used at the wind at any level, in addition to up and down direction of the wind; thereby also improving the service life of the machine;
(4) all components of the wind turbine are sealed, which ensures the work in any harsh environment;
(5) this wind turbine is a double reverse rotary and is effective to solve reverse problem of the machine and reduce the requirements on the infrastructure and support devices;
(6) the wind turbine is low-speed due to its own structural characteristics, which is precisely suitable to large or very large machine;
(7) this wind turbine can lay flat, which is particularly important for a ship;
(8) The structure is simple and reasonable, taking fully account into the processing and installation process for industrial production, thereby the invention is suitable for the industrialized production.

### DESCRIPTION OF FIGURES

FIG. 1 is a schematic of the entire wind turbine;

FIG. 2 is a general assembly drawing of the wind turbine;

FIG. 3 is a schematic diagram of the unstable equilibrium principle;

FIG. 4 shows the mechanical speed regulating principle;

FIG. 5 is an installation schematic diagram of the linkage gear set;

FIG. 6 is an installation schematic diagram of components in the linkage gear case;

FIG. 7 is a working principle schematic diagram of an auxiliary start device;

FIG. 8 is a three-dimensional diagram of the auxiliary start device;

FIG. 9 is a working principle schematic diagram of the vertical shaft of the auxiliary start device in the lower layer wind turbine;

FIG. 10 shows the linkage gear positioning principle;

FIG. 11 shows the linkage of the wind turbine blades;

FIG. 12 shows the power output of the wind turbine.

1—vane vertical shaft, 2—seal ring, 3—ball-race bearing, 4—the top lid of the top layer support, 5—cylindrical support body, 6—lifting lever on the vane vertical shaft, 7—special section lifting lever, 8—the top lid of the linkage gear case, 9—locating pin of the linkage gear case, 10—straight lifting lever on the top blade shaft, 11—top linkage gear, 12—locating pin of the blade shaft, 13—lower linkage gear, 14—nut, 15—gasket, 16—cantilever for supporting the blade shaft, 17—top blade shaft, 18—lower blade shaft, 19—bearing cover, 20—housing of the linkage gear case, 21, 22—the top and lower linkage gear of another wing group, 23—gear on the lower end of the vane vertical shaft, 24—carrier gear, 25—gear on the vertical shaft of the auxiliary start device of the low layer wind turbine, 26—the vertical shaft of the auxiliary start device of the low layer wind turbine, 27—power-output shaft of the top layer wind turbine, 28—linkage steel plate of the top and low blade shaft, 29—sliding bearing, 30—thrust bearing, 31—spring, 32—thrust bearing, 33—cylinder support of the wind turbine, 34—power-output shaft of the low layer wind turbine, 35—main stop block of the linkage gear case, 36—reinforcing rib of the low blade, 37—reinforcing rib of the top blade, 38—limit frame on the tail of the top blade, 39—top blade, 40—low blade, 41—power-output gear of the low layer wind turbine, 42—power-output gear of the top layer wind turbine, 43—tumbler gear, 44—power-input wheel of the machine, 45—hinge, 46—move base, 47—cam, 48—shaft of the lever locking device, 49—lever locking device, 50—top lifting lever of the special section lifting lever, 51—low lifting lever of the special section lifting lever, 52—torsion spring, 53—convex plate of the special section lifting lever.

### PREFERRED EMBODIMENT(S)

The embodiment of the vertical-shaft wind turbine double-layer reverse rotation and horizontal active wings according to the present invention is as follows, wherein a blade is an independent component that is mounted on the blade shaft and with the top or low blade at the some layer wind turbine to assemble a motive wing. Said wing is a blade group which is formed by top and low associated motive blades at the same side in one single layer wind turbine; said following-wind wing acts by wind force, when wind turbine rotates, the angle between blade shaft direction of the against-wind wing and wind direction is 0, a soon-to-be following-wind wing is formed before it becomes following-wind wing. On the contrary, we call it a soon-to-be against-wind wing.

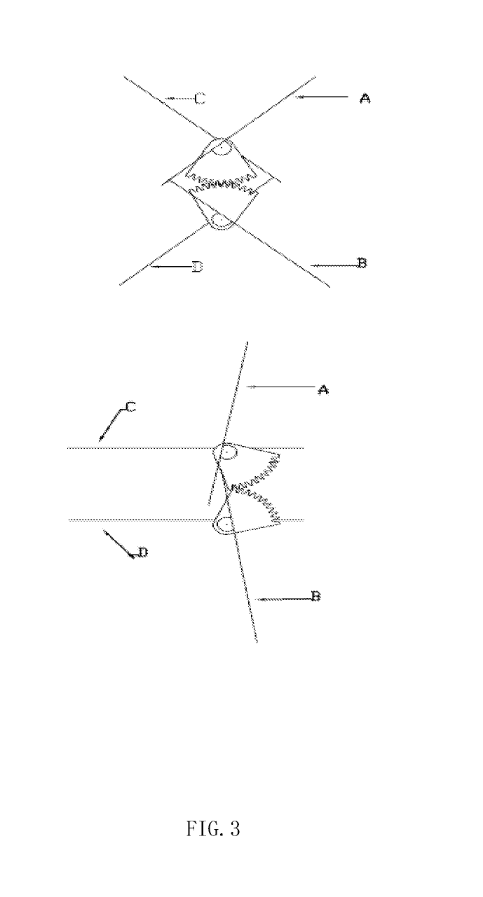

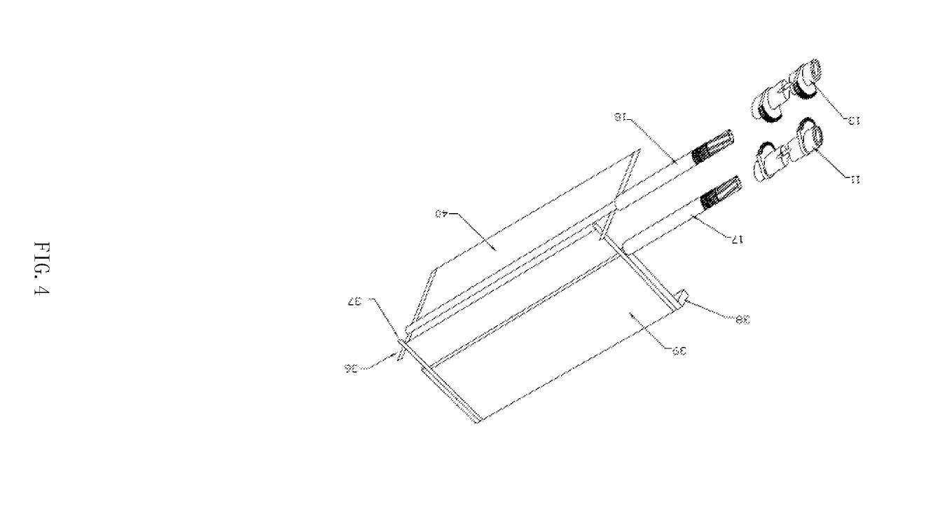

Two groups of assembly wings that are top-down and left-right symmetrical are shown in simplifying form in FIG. 3. As shown, blades A and C are at same shaft to form top blade group, while blades B and D form low blade group. Two blades are engaged by two sector gears that have same pitch diameter and modulus. When blades B and D are static, they are naturally droopy due to their gravity. Because the gravity center of the top blade group is closer to the axis, two blades A and C have to follow blades B and D toward upside. As seen in the Figures, blades A and B, C and D respectively form two wings that are in forward 90° state when they are static. When seeing the force in view of right side, two leaves will quickly opened to 180° from 90° angle; meanwhile, two blades C and D close their angle and are horizontality.

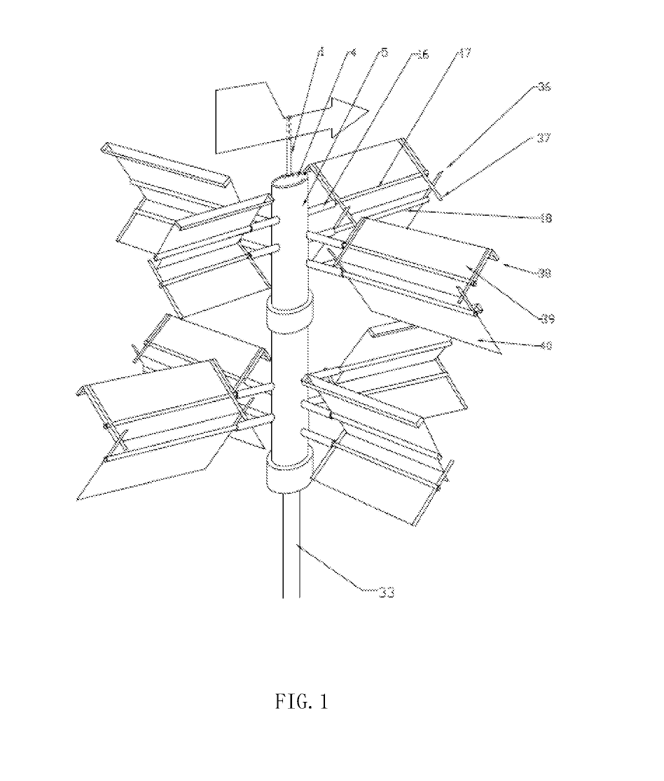

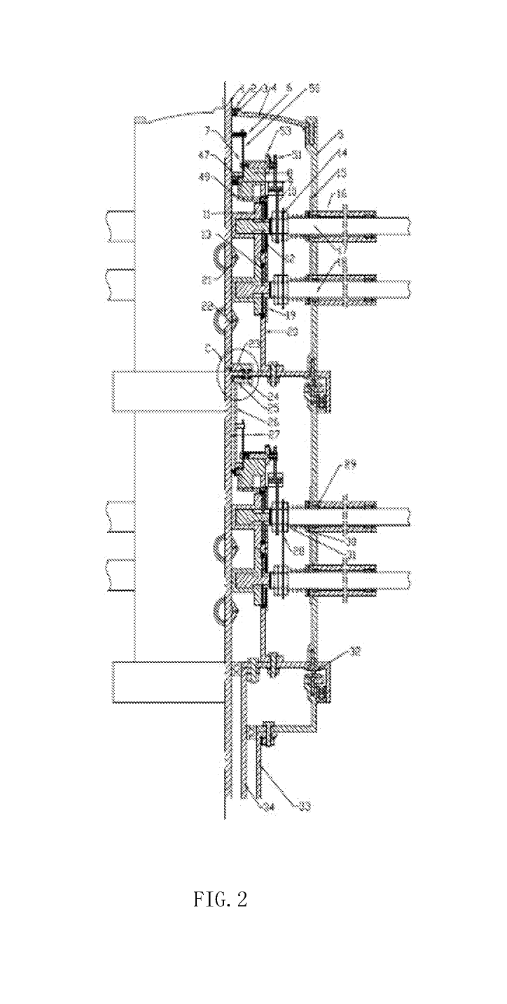

The mechanical speed governors are shown in FIG. 4, spiral key slots are provided in the top and low blade shafts; however, the directions of the spiral key slots are adverse. Form the mounting direction shown in the FIG. 1, the spiral key slots on the top blade shaft of the top lay are dextral (on the low wind turbine being contrary). It can be seen that, when wind turbine rotates too high, the centrifugal force overcome the tension of the spring 31, thereby enable the blade shaft to slide outside and the top blade rotate naturally clockwise. Of course, the low blades rotate in counterclockwise. The result of two rotating blades is what makes open angle becomes smaller, so that the forced area of the following-wind wing will become smaller, and the speed slow down.

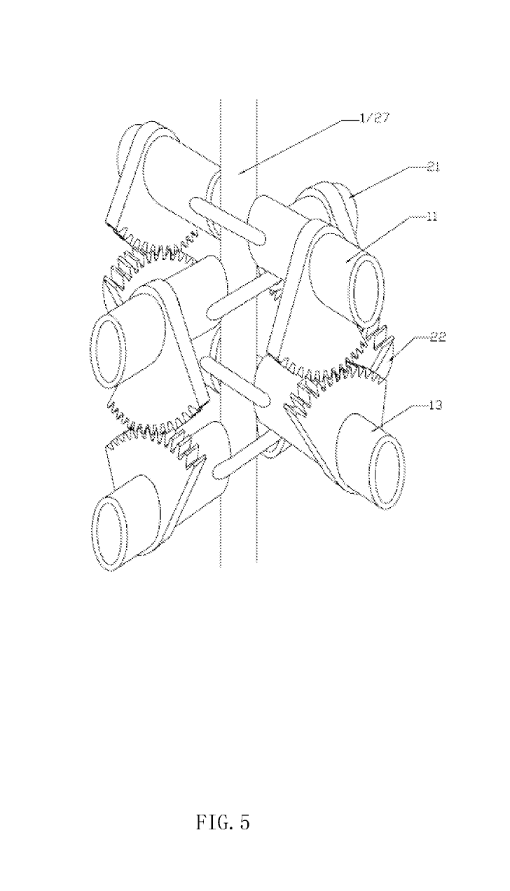

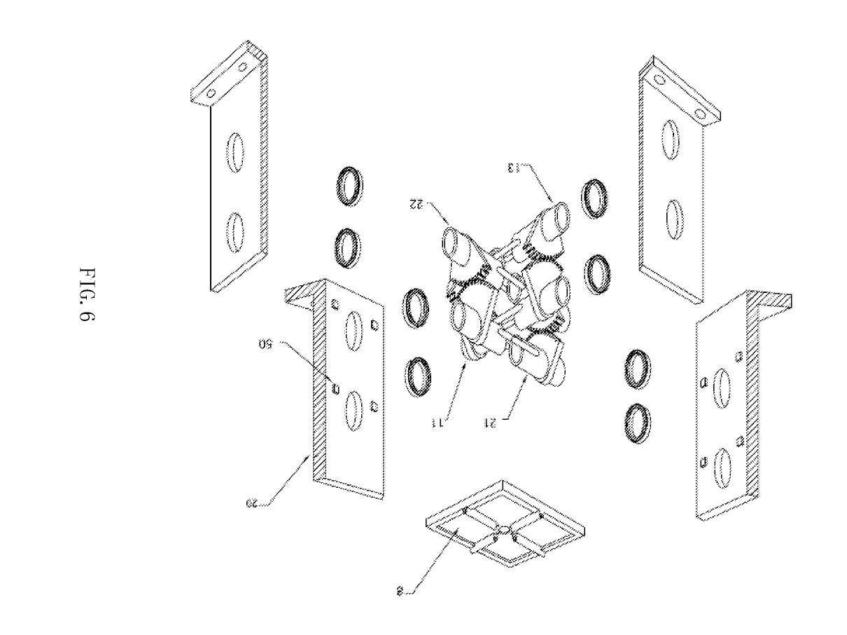

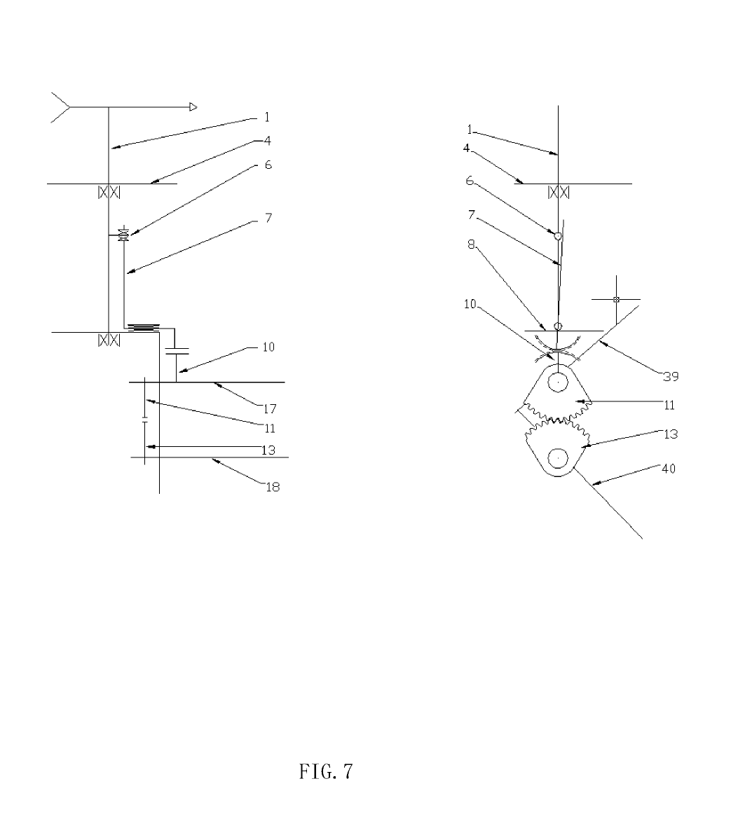

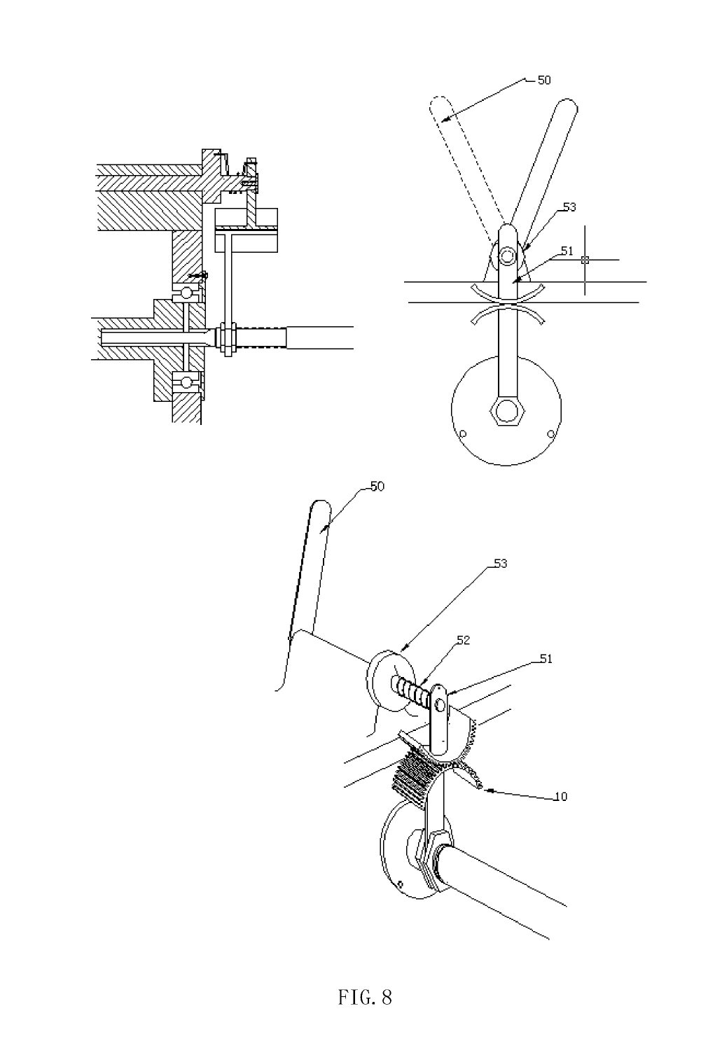

The cooperation between the linkage gears and power-output shaft is shown in FIGS. 5 and 6. As shown, the top wind turbine vane vertical shaft 1 and the top wind turbine power-output shaft 27 must be through the linkage gear set, so the linkage gear should “give way” for them. Although the general linkage gear on both ends are forced simultaneously and homonymously. In order to ensure enough strength, reinforcing ribs are provided at the hollow part that passes through the vertical shaft.

As for why the present invention does not increase the linkage of the diameter of the gear, it is because it can make the four wings of the wind turbine as close as possible in the same horizontal plane. The greatest advantage lies not only in the whole look more coordinated, but also can greatly reduce the height of the machine, and also increase the stability.

FIG. 7 is a schematic diagram of the auxiliary start device according to the present invention, and FIG. 8 is an entity schematic diagram of this part. In FIG. 8 a lifting lever 50 is at the position when the wind turbine is at ready mode. According to the mounting method shown in the FIG. 1, the tangent of the movement trajectory of the top lifting lever 50 of the wind turbine is from right to left, the vane vertical shaft is basically fixed; thus rollers 6 are basically fixed too, so that the lifting lever 50 drives the lifting lever 10 to tilt to left, thus driving the top blade shaft to rotate, and the angle between two blades rapidly open from 90°.

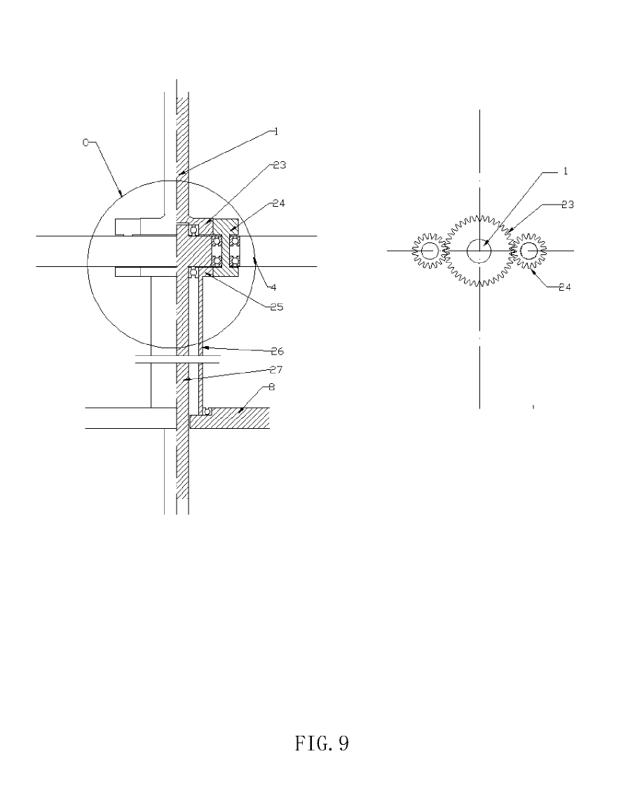

Lower wind turbine certainly also need an auxiliary start device, according to the present invention, as shown in FIG. 9, gears 23 are provided at the bottom of vane vertical shaft, while carrier gears 24 are provided at the low end cover of the wind turbine; the power-output shaft 27 and the low end cover of the wind turbine are integrated. A steel pipe 26 is installed at the outer side of the shaft 27, a gear 25 which is connected with the gear 23 of same pitch diameter via the carrier gear 24 is provided at the upper end of the steel pipe 26. Analysis shows that, when the vertical shaft do not rotate, the rotation of the upper layer wind turbine just drive the carrier gear 24 to produce a planetary effect, as a result of this effect, the gear 25 maintains synchronization with the gear 23. In doing so, the auxiliary starting device which is the same as the one provided at the upper layer wind turbine can be mounted at the lower layer wind turbine (certainly, the direction being adverse). When actually works, as the directions of the top and lower layers of the wind turbines are opposite; two auxiliary starting devices produce equal and opposite force in work, which further ensures the stability of the wind vane.

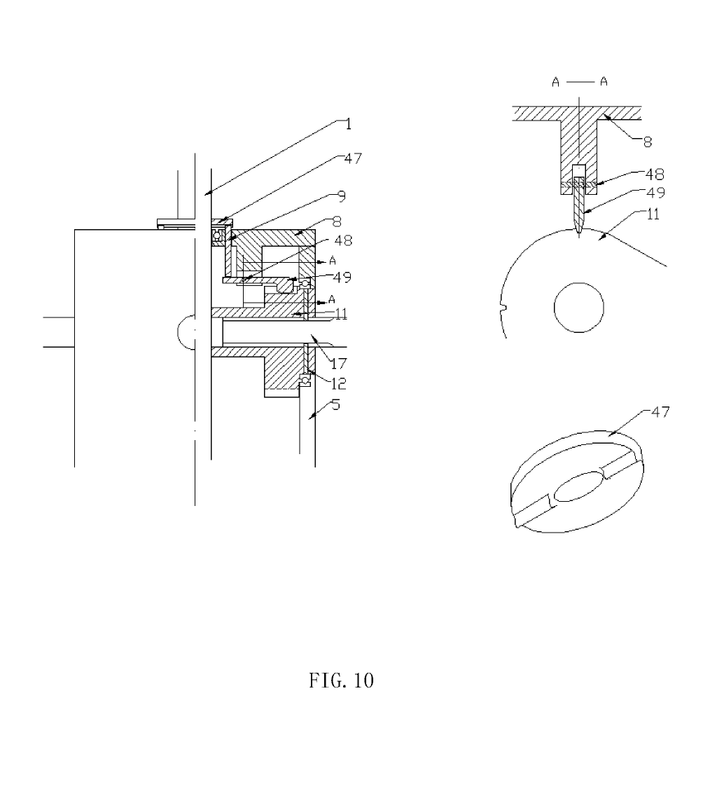

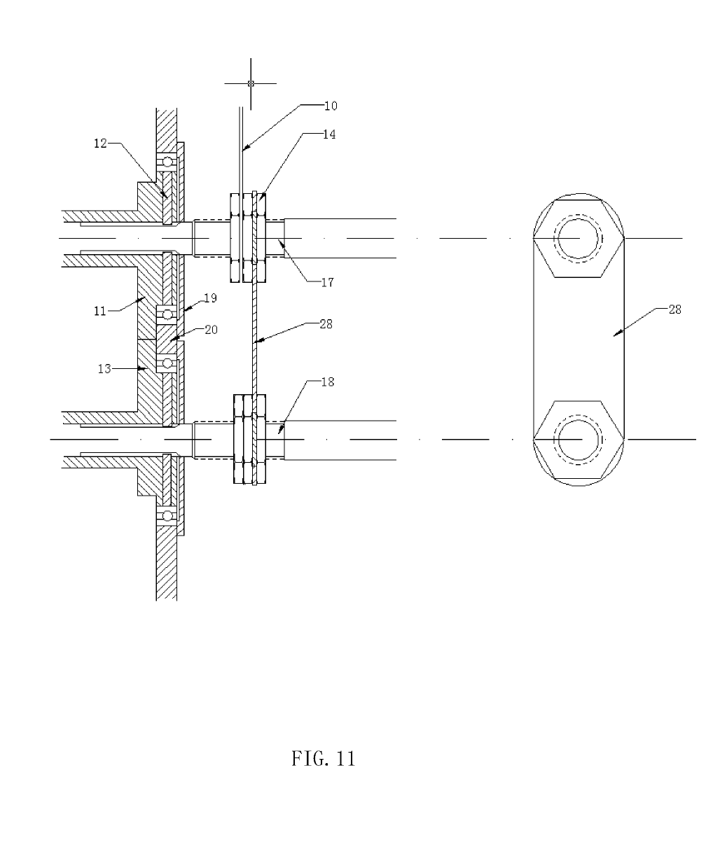

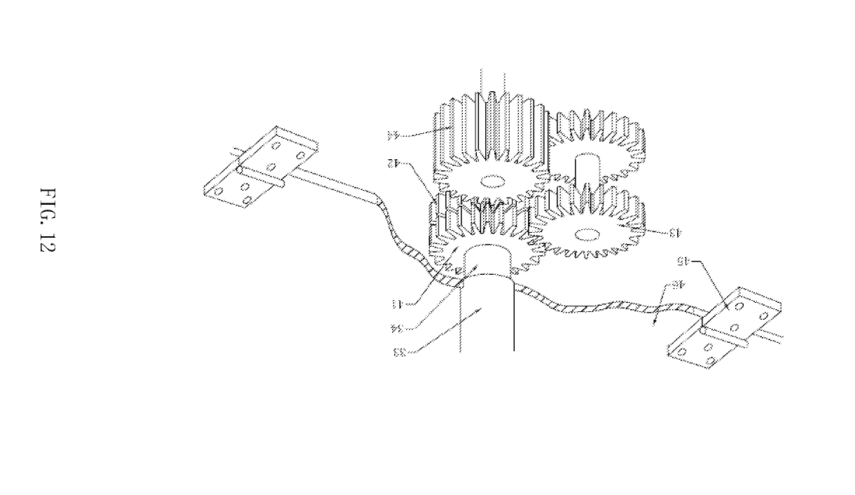

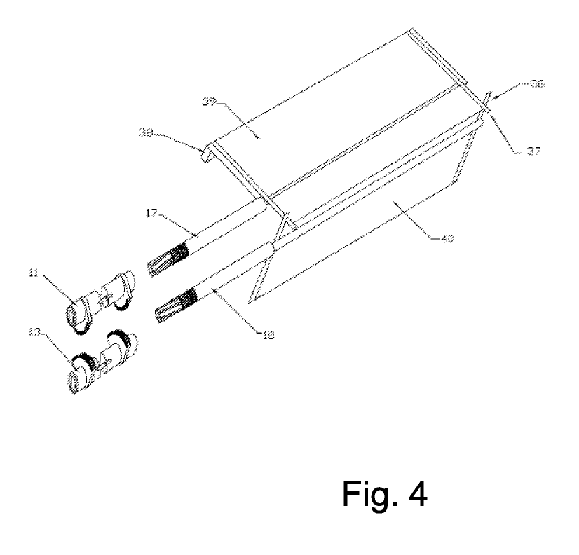

The positioning of the linkage gear of the present invention is shown in FIG. 10 which is a larger schematic of this part. As seen from FIG. 10, two positioning slots are provided in the linkage gear 11. When the following-wind wing is fully open and the against-wind wing is completely parallel, the linkage gear is locked via that the front end of the lever locking device 47 as its gravity falls into the positioning slot linkage of the linkage gear 11. In doing so, when the following-wind wing rotating and the angle between which and wind direction is too big; thus, the wind force cannot keep it open, and the following-wind wing cannot keep horizontality; thereby, reducing the resistance force of the against-wind wing.

In the present invention, it is not allowed that the following-wind wing open to 180° (meanwhile the against-wind wing being 0°) when passed by the auxiliary-start lifting lever 6. One case is that if the wind turbine automatically regulates speed, then the against-wind wing will close in advanced due to the effect of the tail part of the limit frame 38. And if the lifting lever 6 continues to exert force on the special-shaped lever; then it could cause irreparable damage. Another case is that when the wind speed gradually slows down until stop, each wing can not renew to the best ready state. Therefore, the special-shaped lever must be assembled when the wind turbine is at its best ready mode and the lifting lever 50 is not completely vertical, but tilts left somewhat, which inclination is 0° when the against-wind wing is closed; the top of the lever 50 is higher than the lever 6, when the open angle of the following-wind wing which is completely separated from the lever 6 do not reach 180°. Therefore, the against-wind wing of the wind turbine is not entirely initiated by the auxiliary start device to open to 180°; the auxiliary start device can only enable the wings open to less than 180° when the against-wind wing becomes soon-to-be following-wind wing. That is when a knife-type positioning device 49 do not falls into the positioning slot 11 of the linkage gear; then, the wing is opened to 180° by wind force. In doing so, the wind gradually decreases and is not enough to continue working that is when machine stops. The machine will automatically back the best standby state due to the unstable equilibrium described above.

Because the blade shaft is associated with the positioning pin 12, when the lever 50 rotates, by which the blade shaft is driven to rotate; however, the front end of the linkage gear lever positioning device 49 has not yet lifted, that is linkage gear 11 is locked; so the linkage gear cannot rotate, and exerting force must cause deleterious effect. In order to solve this problem, we designed a low lifting lever which can relative rotate and is connected with the convex plate 53 via a torsion spring 52, so that the lever 51 and lever 50 is associated and can relative rotate.

In general, the torsional spring 52 do not force the lower lifting lever 51. During the early rotation of the lever 50 and the cam 47 has not yet put pressure on the front end of the lever locking device 49; thus the blade shaft cannot rotate, and meanwhile the lower lifting lever 51 and the lever 50 form a flexible association via the deformation of the torsion spring 52. Once the cam 47 exerts torsional force on the lifting lever 51, the straight lifting lever 10 is driven to rotate. As mentioned above, the force which is exerted on the special shaped lever 7 by the lifting lever 6 is not enough to enable the following-wind wing to fully open to 180°, but it will help the against-wind wing to fully open. Said special shaped lever 7 consists of a lower lifting lever 50, a top lifting lever 51, a torsional spring 52 and a convex plate 53.

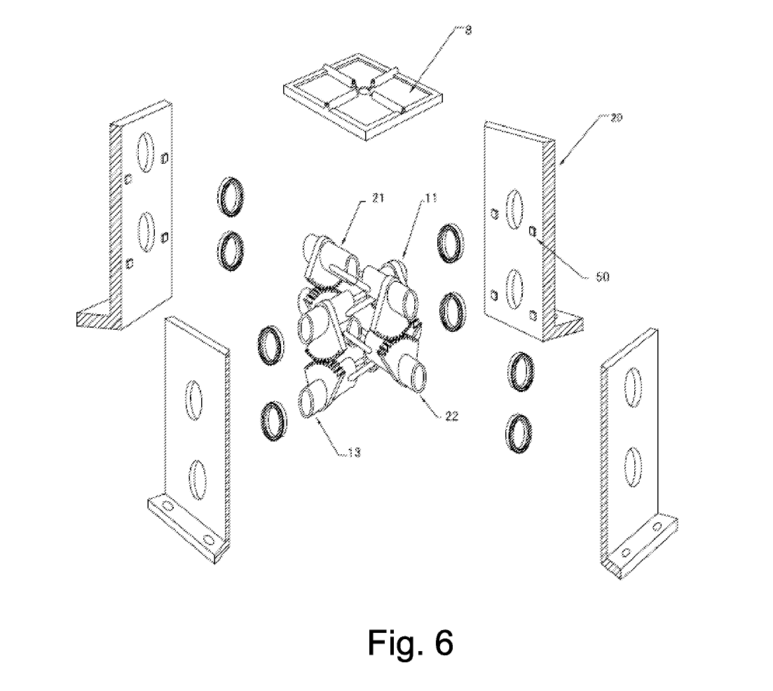

The blade shaft linkage is shown in FIG. 11. The figure shows that, in order to ensure the wind turbine in the automatic speed control, the special shaped lever and the straight lever 10 on the blade shaft maintain in combination during the blade shaft moves outside. According to the present invention, a widened sector gear is used, whose width should be able to ensure the good engagement until the blade shaft moves to the outermost side. The linkage piece 28 is a steel disc that has holes on both ends covering the locknuts of the top and low blade shaft respectively. There is gap between the locknuts and the holes, so the blade shaft can still rotate freely. In doing so, when the wind turbine regulates the speed, the displacement difference between two blade shafts which is produced by different elasticity of the spring 31 can be avoided, so as to ensure the cooperation of the limit reinforcing ribs 36, 37 of the top and low blades.

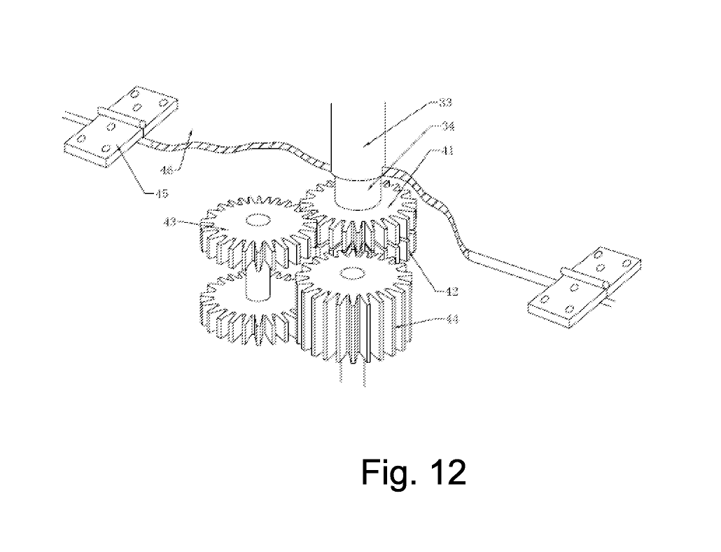

The power-output device of the present invention is shown in FIG. 12. The figure shows the power-input gear 44 is directly engaged with the power-output gear 42 of the top layer wind turbine, and the power-output gear 41 is associated with the gear 44 via the tumbler gear 43.

The present invention is further described by the following example of the top layer wind turbine combined with the drawings and embodiments. Except the cover of the linkage gear case and the lower end cover have slight difference, and appropriate changes of the installation has been made due to the opposite rotating directions, the lower layer wind turbine has same structure as the top layer wind turbine, so there is no need here to explain the lower layer wind turbine.

When the wind is from the northeast direction (in accordance with the labeling rules on the map), the wind turbine began to rotate clockwise (top view). However, the following-wind wing may not fully open, so the part 50 of the special shaped lever of the soon-to-be following-wind wing come into contact with the lifting lever 6 of the vertical shaft 1 and rotate clockwise (tilting to right) by the lifting lever 6. When it tilts to a certain point of view (for example 30°), the lever 6 is separated from the lever 50. Therefore, the lever 6 is no longer put pressure on the lever 10 of the blade shaft via the special shaped lever, and the blade shaft will not rotate. But if the wind is strong at a certain degree, and at this time the following-wind wing will fully open immediately in the presence of wind. And the result is that the positioning slot on the linkage gear rotates to the highest point and the front end of the lever locking device 49 will falls into the positioning slot on the linkage gear as its gravity to lock the linkage gear. When the following-wind wing becomes soon-to-be against-wind wing, the corresponding against-wind wing becomes soon-to-be following-wind wing, and above process start to repeat.

If the wind increases, the wind turbine rotation speed exceeds the limit, and the centrifugal force of the blades is greater than the elasticity of the spring 31 of the blade shaft, and the blade shaft is driven to slide outside. As mentioned above, because of the spiral key slot on the blade shaft, the following-wind wing will not open to 180°, and the speed of the wind turbine slows down. There is another possible, if the wind is too strong, the open angle of the following-wind wing is less than 30° as the effect of the limit frame on the tail of the against-wind wing,

And the force which is exerting on special shaped lever by the lifting lever will be eliminated by torsional spring, which avoids the damage of wind turbine auxiliary starting device.

When the wind speed gradually decreased, until is not sufficient to maintain the rotation of the wind turbine, and cannot continue to open the following-wind wing which opens to 30°. That is, the against-wind wing cannot continue to lock at its horizontal state. In this way, each wing remains the best standby when the wind turbine finally stops.

According to the power-output device of the machine, the power of the top and lower layers wind turbines which is rigid connected drive the same power generator simultaneously. Its purpose is very clear, in order to ensure the top and lower wind turbines to be able to operate simultaneously, thus avoiding torque difference to the whole tower frame. In addition, as shown in the drawing, the blade is clamped in the blade shaft. The upper and lower blades are placed in deviation from the blade shaft so as to ensure the upper and lower blades of the same wing will not become against to each other. If the blades need to be processed into a hyperbolic shape,

The upper and lower blades in a vertical state should be placed in two vertical planes respectively, so that the blade will not push against it.

Comparing the wind turbine with the traditional horizontal wind turbine, the greatest advantage is that the machine height is reduced and the speed can be regulated during all the way. Only from the height advantage, just a rough estimate, compared to a wing length of 45 meters of horizontal shaft wind turbine, if the wing length of the machine according to the present invention is 45 m too, and the cantilever is 25 m, the length of the blade is 20 m, the width of each blade being 1.5 meters will achieve the same energy conversion efficiency. In other words, the shaft center height of the horizontal shaft wind turbine must bigger than the length of the wing, for example, when the wing length is 45 m, the shaft center height of the blade must bigger than 45 m; and the installation distance between two wind turbines must be greater than 90 m; while at same situation, two even three machines according to present invention can be installed, and the installation distance between two wind turbines only need to be greater than 45 m. In doing so, the efficiency of wind energy utilization is greatly increased. Therefore, it is more suitable for high-rise buildings, wind farms in the mountains, and more suitable than the vertical wing and vertical shaft wind turbine of the Japanese company mentioned above for ships. And this machine is the preferred model for wave power generation. Because seawater density is far greater than the air, therefore, there is no need to mount the vane and relatively complex auxiliary start device; such as the fixing ring for catching the anchor chain can be provided at the position which is for the vane. The wind turbine is inverted mounted below the buoy and the generator is installed in the buoy barrel, while the electrical equipment is also installed in the buoy barrel; thus, this beacon of light will be able to truly unattended. More noteworthy is that the machine does not need a large reservoir like the traditional tidal power station and needs not to be built in the profundal zone. Because the shaft is vertical, so any direction of the waves can drive the machine.

In addition, a limit frame 38 is provided at the tail of the top blade to protect the blade. If the blade material has sufficient strength, this framework may not be used. In doing so, the biggest benefit is that if the wind is too strong, and when the rotation of wind turbine over speed, the against-wind wing will open, which further slow down the rotation speed of the wind turbine.

The present invention is detailed described by above description and embodiments, but it is obvious for the people skilled in the art to modify or improve the solution base on the present invention. Therefore, the patent is intended to cover modifications and equivalent arrangements that are within the spirit and scope of the appended claims.

What is claimed is:

1. A vertical-shaft wind turbine double-layer reverse rotation and horizontal active wings consist of support devices and blades etc., characterized in that: further including a movable wing link gear, a positioning device, a stop device, an auxiliary start device, a speed adjusting device and blade shaft; wherein the movable wing link gear, the positioning device and the auxiliary start device are all mounted in the body of the wind turbine; the blades are associated with the blade shaft; the speed adjusting gear is between the blade shaft and the linkage gear of the movable wing link gear; the stop device is mounted on the side wall of the linkage gear case, the auxiliary limitation devices are mounted at the front ends of the top and lower blades and the tail of the top blade respectively.

2. The wind turbine according to claim 1, characterized in that, said support devices includes a upper and lower support, and the two support both are cylinder and associated with each other; they rotate around one vertical axis, however, their rotation directions are opposite.

3. The wind turbine according to claim 1, characterized in that, the cantilevers of the four groups of the support blade shafts are provided at the outer surface of said cylinder support device; and a bearing bush in the cantilever is in slide conjunction with the blade shaft, which is also in conjunction with a seal ring provided at the outside of the cantilever.

4. The wind turbine according to claim 1, characterized in that, each double-layer reverse rotation vertical-shaft wind turbine group using horizontal combination active wing of said movable wing link gear consists of two upper blade shafts, two lower blade shafts, four blades and two linkage gears which have same pitch diameter and same modulus and are engaged with each other; pins which are in conjunction with the multiple spline on the blade shaft are provided at two ends of the linkage gear.

5. The wind turbine according to claim 1, characterized in that, one of the linkage gear of said movable wing link gear vertically passes through the upper and lower linkage gears of another movable wing link gear group.

6. The wind turbine according to claim 1, characterized in that, stop blocks are provided at the suitable place of the inner wall of each gear case to limit the move range of the linkage gear; meanwhile, reinforcing ribs are mounted at the two inner and outer ends of each blade and protrude forward; a “U” shaped frame is provided at the tail of the upper blade to act as an auxiliary stop device.

7. The wind turbine according to claim 1, characterized in that, said multiple spline of the speed adjusting device is in slide conjunction with the linkage gear shaft.

8. The wind turbine according to claim 1, characterized in that, said auxiliary start device is mounted on the vertical shaft of the vane mounted on the upper layer wind turbine, and lifting levers are mounted on the suitable place which is in same direction of the vane arrow; and a special shaped lifting lever (7) is provided on the upper end cover of the linkage gear case; meanwhile, lifting levers are mounted on the upper blade shaft of each group of motive wing; a casing tube is provided on the linkage gear case of the lower layer wind turbine; at the arrow direction of the vane, lifting levers are mounted on the casing tube which is in conjunction with the vertical shaft of the vane via a carrier gear.

9. The wind turbine according to claim 1, characterized in that, two positioning slots are provided at the upper linkage gear of each layer wind turbine, when the turbine is in regular work, the positioning pin of the linkage gear case just falls into the positioning slot to lock the linkage gear; when the wing plane which is associated with the locked linkage gear turns until the angle between itself and wind is 0, the cam of the lower end of the vane vertical shaft (the casing tube of the lower layer wind turbine) drives the lever to lift; thus the linkage gear is unlocked, and each wing enter into now working mode.

10. The wind turbine according to claim 1, characterized in that, if maintenances are needed, the blades can be opened to horizontality by moving the blade shaft outside in exterior or interior.
